(19) United States
(12) Patent Application Publication
(10) Pub. No.: US 2009/0010699 A1
(43) Pub. Date: Jan. 8, 2009

(54) SYSTEM FOR SIMULTANEOUSLY MODIFYING A PLURALITY OF AREAS ON A SHEET

(75) Inventors: Steven Skalski, Allen, TX (US); John F. Jones, El Cajon, CA (US)

Correspondence Address: BRINKS HOFER GILSON & LIONE, P.O. BOX 10395, CHICAGO, IL, 60610, US

(73) Assignee: GRAPHIC CONVERTING, INC., Elmhurst, IL (US)

(21) Appl. No.: 11/773,860

(22) Filed: Jul. 5, 2007

(51) Int. Cl. B41J 11/00

(52) U.S. Cl. 400/582; 235/494

(57) ABSTRACT

A system is described for simultaneously modifying a plurality of areas on a sheet. The system may include a plurality of print heads, a sheet, a conveyor, a memory, an interface, and a processor. The plurality of print heads may be operatively connected to the processor and may be configured to modify a plurality of areas on a sheet. The conveyor may be operatively connected to the processor and may pass the sheet beneath the plurality of print heads. The memory may be operatively connected to the processor and may store a set of data comprising a plurality of modifications to the plurality of areas on the sheet. The interface may be operatively connected to the processor and the memory and may receive the set of data. The processor may be operatively connected to the conveyor, the memory, the interface and the plurality of print heads. The processor may receive the set of data via the interface. The processor may associate each print head in the plurality of print heads to each area in the plurality of areas and to each modification in the plurality of modifications. The processor may instruct the conveyor to pass a sheet beneath the plurality of print heads. The processor may instruct the plurality of print heads to simultaneously modify the plurality of areas on the sheet based on the plurality of modifications. Each print head in the plurality of print heads may simultaneously perform the modification in the plurality of modifications associated with each print head on the area in the plurality of areas associated with each print head.

### TECHNICAL FIELD

The present description relates generally to a system and method, generally referred to as a system, for simultaneously modifying multiple areas of a sheet, and more particularly, but not exclusively, to simultaneously printing indicia to multiple cards on a sheet.

### BACKGROUND

Players of trading card games and collectible card games may collect cards, or decks of cards, which may be used to play a game. The cards may each have a specific function, or utility, in the card game and each card may have a varying degree of value associated with the function. There may be differing levels of availability of the cards, whereby some cards may be rarer than others. The more utility a card may have in the card game the less available the card may be to the players. The players may collect their own deck of cards and use their specific cards to compete against other players.

There may be online collectible card games which users may play over the internet. The online collectible card games may embody the same basic principles as the physical collectible card games; however, players of the online collectible card games may collect “virtual” cards as opposed to physical cards. The “virtual” cards may only exist in digital form in the realm of the online card game. Players may be unable to use their personalized decks of physical collectible cards in the online card games. The inability to use the physical cards in the online play may be a result of an inability to efficiently print unique indicia on each card in each deck. Since each card has a specific function and value, it is necessary for each card to have a unique indicia printed on it. The unique indicia may make each card identifiable in the online realm.

The traditional process of printing collectible playing cards may involve printing cards in a standard sheet format. Thus, an entire sheet of cards may be printed with one pass through a printer. However, in order to print a unique indicia or marker on each individual card on a sheet, the sheets may need to be cut into individual cards and the cards may need to be printed on one-by-one. Printing on the cards individually may be time intensive and expensive and may render standard printing processes and efficiencies inoperative. Therefore there may be a need for a system for printing unique indicia on individual cards in a standard sheet format.

### SUMMARY

A system is disclosed for simultaneously modifying multiple areas of a sheet. The system may include a plurality of print heads, a sheet, a conveyor, a memory, an interface, and a processor. The plurality of print heads may be operatively connected to the processor and may be configured to modify a plurality of areas on a sheet. The conveyor may be operatively connected to the processor and may pass the sheet beneath the plurality of print heads. The memory may be operatively connected to the processor and may store a set of data comprising a plurality of modifications to the plurality of areas on the sheet. The interface may be operatively connected to the processor and the memory and may receive the set of data.

The processor may be operatively connected to the conveyor, the memory, the interface and the plurality of print heads. The processor may receive the set of data via the interface. The processor may associate each print head in the plurality of print heads to each area in the plurality of areas and to each modification in the plurality of modifications. The processor may instruct the conveyor to pass a sheet beneath the plurality of print heads. The processor may instruct the plurality of print heads to simultaneously modify the plurality of areas on the sheet based on the plurality of modifications. Each print head in the plurality of print heads may simultaneously perform the modification in the plurality of modifications associated with each print head on the area in the plurality of areas associated with each print head.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for simultaneously modifying multiple areas of a sheet.

FIG. 2 is block diagram of a component view of a system for simultaneously modifying multiple areas of a sheet.

FIG. 3 is a flowchart illustrating the operations of the systems of FIG. 1 and FIG. 2, or other systems for simultaneously modifying multiple areas of a sheet.

FIG. 4 is a flowchart illustrating steps that may be taken in the printing process in the systems of FIG. 1 and FIG. 2, or other systems for simultaneously modifying multiple areas of a sheet.

FIG. 5 is an illustration of an exemplary sheet layout in the systems of FIG. 1 and FIG. 2, or other systems for simultaneously modifying multiple areas of a sheet.

FIG. 6 is an illustration of layout data files in the systems of FIG. 1 and FIG. 2, or other systems for simultaneously modifying multiple areas of a sheet.

FIG. 7 is an illustration of an exemplary modified sheet in the systems of FIG. 1 and FIG. 2, or other systems for simultaneously modifying multiple areas of a sheet.

FIG. 8 is an illustration a general computer system that may be used in the systems of FIG. 1 and FIG. 2, or other systems for simultaneously modifying multiple areas of a sheet.

### DETAILED DESCRIPTION

A system and method, generally referred to as a system, relate to simultaneously modifying multiple areas of a sheet, and more particularly, but not exclusively, to simultaneously printing indicia to multiple cards on a sheet. The principles described herein may be embodied in many different forms.

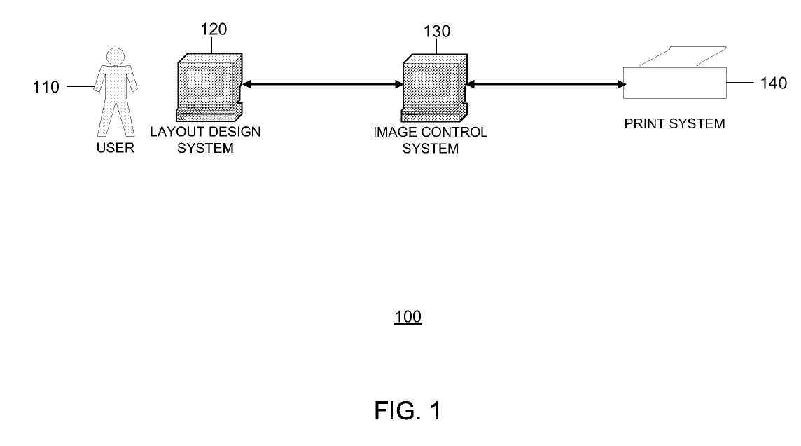

FIG. 1 provides a general overview of a system 100 for simultaneously modifying multiple areas of a sheet. Not all of the depicted components may be required, however, and some implementations may include additional components. Variations in the arrangement and type of the components may be made without departing from the spirit or scope of the claims as set forth herein. Additional, different or fewer components may be provided.

The system 100 may include a user 110, a layout design system 120, an image control system 130, and a print system 140. The layout design system 120, the image control system 130, and the print system 140, may be in communication with one another, such as through a network. The layout design system 120, image control system 130, and print system 140, may each include a processor, a memory, a display, and an interface capable of inputting, outputting, displaying, or communicating data.

In operation, the user 110 may use the layout design system 120 to create one or more layout data files. The layout data files may indicate the existing layout of one or more printed sheets, such as a printed sheet of cards, and the modifications to be made to individual areas on the sheet, such as individual cards or fields on individual cards. The layout data files may be created in a spreadsheet application such as MICROSOFT EXCEL. The layout data files may be compiled into a master machine data file and communicated to the image control system 130. The image control system 130 may use the data in the master machine data file to communicate imaging, or printing, instructions to the print system 140. The print system 140 may use a plurality of print heads to simultaneously print unique indicia on multiple areas of a sheet, such as on individual cards of a sheet of cards for a collectible card game or a trading card game. Alternatively or in addition, the system 100 may be used to print labels, tickets, price tags, or generally any sheet of items which may benefit from modifying multiple areas simultaneously.

The indicia printed to the cards may be sequential numbering, variable data, codes, or secondary graphics. Alternatively or in addition the print system 140 may use solvents or solutions to simultaneously remove inks or coatings from multiple areas of the sheet to reveal the substrate below. Thus, the imaging process may refer to printing indicia onto a medium, such as a sheet, or applying a solution or solvent to remove existing ink from a medium.

In the case of trading cards, each modifiable area on the sheet may relate to each card on the sheet. The modification of the card may result in a unique identifier being printed on the card which may be used with the master machine data files to determine an association with other cards on the sheet. A player may be able to use the unique identifier to access an online database which may contain information pertaining to the card or any other cards printed on the same sheet. Alternatively or in addition a player may be able to enter the unique identifier on each card into an online game to “transfer” the card to their virtual deck of cards. The player may enter the unique identifier of each card individually, or the player may be able to enter the unique indicia on one card and retrieve the information relating to all of the cards in their deck.

More detail regarding collectible card games or trading card games, as well as their structure, function and operation, can be found in U.S. Pat. No. 5,810,666, filed on May 8, 1996, entitled “ROLE PLAYING GAME,” and U.S. Pat. No. 5,934,332, filed on Jan. 30, 1998, entitled “ROLE PLAYING GAME,” all of which are hereby incorporated herein by reference in their entirety. The systems and methods herein associated with collectible card games, trading card games, or cards in general may be practiced in combination with methods and systems described in the above-identified patent applications incorporated by reference.

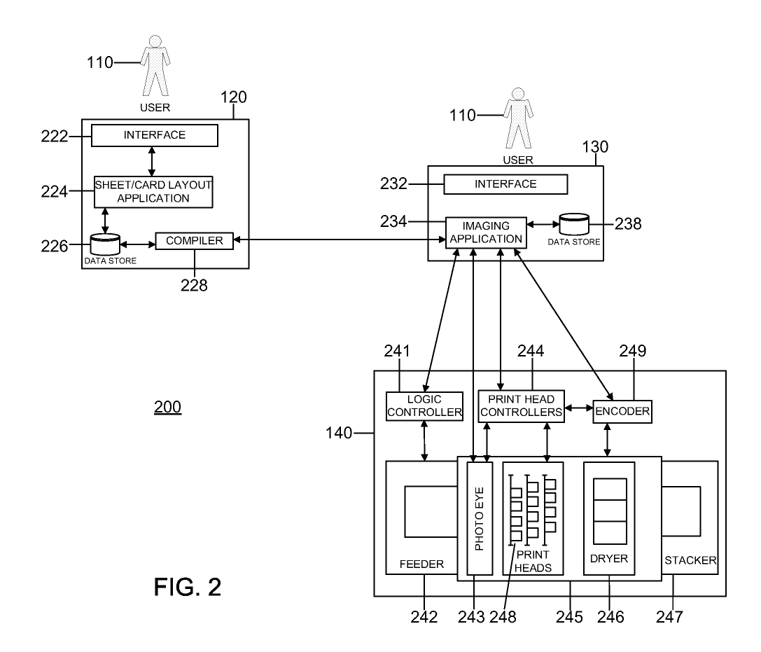

FIG. 2 provides a component view of a system for simultaneously modifying multiple areas of a sheet. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 200 may include one or more users 110, a design layout system 120, an image control system 130, and a print control system 140. The design layout system 120, image control system 130, and print control system 140 may be in communication with one another, such as through a network, direct connection, or generally any connection capable of communicating data. The design layout system 120 may include an interface 222, a sheet/card layout application 224, a data store 226, and a compiler 228. The image control system 130 may include an interface 232, an imaging application 234, and a data store 238. The printing system 140 may include a logic controller 241, a feeder 242, a photo eye 243, one or more print head controllers 244, a vacuum conveyor 245, a dryer 246, a stacker 247, a plurality of print heads 248, and an encoder 249.

In the design layout system 120, the interface 222 may be an input, output, and/or display component that may allow the user 110, or the other systems, to interact with the design layout system 120. The interface 222 may include one or more of a monitor, keyboard, mouse, communication device, or any other devices capable of inputting, outputting, and/or communicating data. The sheet/card layout application 224 may be a software application which may assist the user 110 in creating layout data files and card format files. The data layout files may be in any data format, such as XML format, comma-delimited format, or MICROSOFT EXCEL format. The data layout files may include one or more of a sheet layout file and a card layout file.

The software application may be a graphical user interface which may assist the user 110 with placing indicia on a sheet of cards, or may be a spreadsheet editing application, such as MICROSOFT EXCEL. The data store 226 may be any database such as MICROSOFT SQL SERVER, ORACLE, IBM DB2 or any other database software, relational or otherwise, data structure, or device capable of storing data, such as a hard drive, memory or removable storage medium. The compiler 228 may be a software application, such as PRISM GAMES BUILDER which may compile each of the data layout files into machine data files. The compiler 228 may also compile all of the individual machine data files into a master machine data file.

Alternatively or in addition the sheet/card layout application 224 may provide a graphical user interface to assist the user in creating the card format files. The card format files may describe the number and size of fields on a card where data may be modified, such as the boundaries of each printable area on a card. The card format may be loaded onto flash memory cards in the print head controllers 248.

The master machine data file may contain a compilation of the data from the individual machine data files, such as the orientation and/or distribution of the data to be printed to the sheets and the sequence and/or status of the sheets to be printed. The orientation of the data may refer to the order in which the data may be communicated to the individual print head controllers 244 and the distribution of the data may refer to the manner in which the data is distributed amongst the print head controllers 244. The sequence of the sheets may refer to the order in which the sheets may be printed, and the status of the sheets may refer to whether the data for a particular sheet has been communicated to the print heads controllers 244 and, if so, a date/time stamp indicating the time of the communication. The master machine data file may be communicated to the image control system 130.

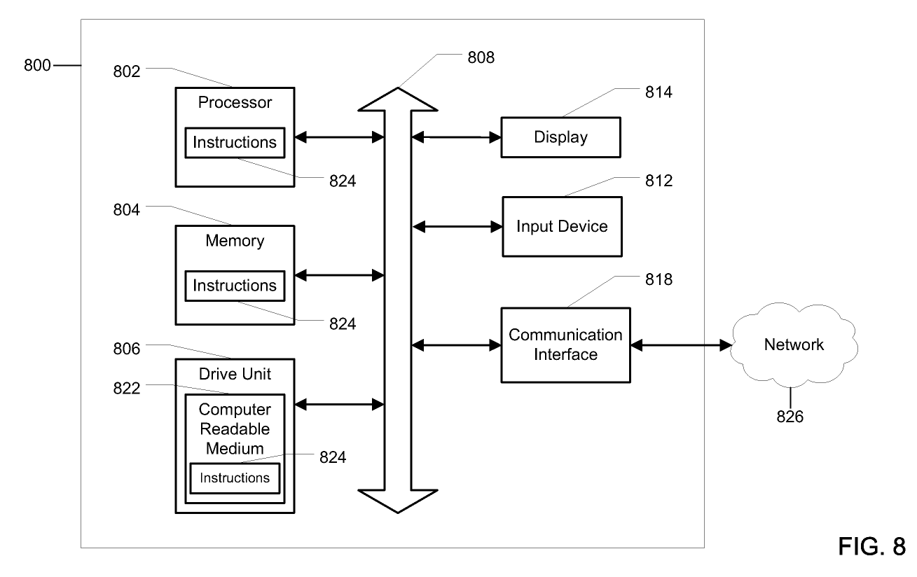

In the image control system 130, the interface 232 may be an input, output, and/or display component that may allow the user 110, or the other systems, to interact with the design layout system 120. The interface 232 may include one or more of a monitor, keyboard, mouse, communication device, or any other devices capable of inputting, outputting, and/or communicating data. The imaging control system 130 may include a computer, such as the one described in FIG. 8. The computer may execute an imaging application 234, such as MAILPRO, which may allow the user 110 to interface with the image control system 130 and the print system 140. The imaging application 234 may allow the user 110 to view the status of files, the status of the systems' readiness, and to make adjustments in the printing process. The computer may be multiplexed, via a multiplexer, to the encoder 249, photo eye 243, and print head controllers 244. The master machine data file may be an input to the imaging application 234. The data store 238 may be any database such as MICROSOFT SQL SERVER, ORACLE, IBM DB2 or any other database software, relational or otherwise, data structure, or device capable of storing data, such as a hard drive, memory or removable storage medium. The data store 238 may store the master machine data file or any other data.

In the print system 140, the logic controller 241, such as an ALLEN BRADLY MICROLOGIX, may be in communication with the image control system 130 and each of the components in the print system 140. The logic controller 241 may communicate the status of the components in the print system 140 to the image control system 130, may stop the components in the print system 140, or may communicate any other instructions to the individual components in the print system 140. The logic controller 241 may be programmable.

The feeder 242, such as a TEC LIGHTING, INC. # FED-007 Deep Pile Suction Cup Feeder, may feed sheets to the printing system 140 via the vacuum conveyor 245. The vacuum conveyor 245, such as a J.L. CUSTOM INC. ACCUJET, may move the sheet through the print system 140. The photo eye 243, such as a SICK VL180-n132, may monitor when sheets may be fed by the feeder 242. The photo eye 243 may be in communication with the imaging application 234 and the print head controllers 244 and may communicate when a sheet passes beneath the photo eye 243 to both components.

The one or more print head controllers 244, such as the PRISM JETPACK (JP 1000), may instruct the print heads 248 to simultaneously modify the data on multiple areas of a sheet. Each print head controller 244 may have a processor, a memory, such as a flash memory card, and a display. The print head controllers 244 may be in communication with the imaging application 234, the encoder 249, the print heads 248, and the photo eye 243. The memory may be used to buffer data to be printed to one or more sheets. The amount of data which may be buffered may depend on the size of the memory.

The print heads 248 may be comprised of four pens, such as four half-inch wide HP 45A printer cartridges. The print heads 248 may be configured so that each print head 248 is associated with an area of the sheet. The print heads 248 may be capable of modifying the associated area of the sheet. In the case of a sheet of cards, the print heads 248 may print a unique indicia or identifier on each card, such as a bar code or a number. The size of the area of the sheet may be determined by the size of the printer cartridges. For example, a half-inch wide cartridge may be capable of printing on a half-inch wide area of the sheet, spanning the length of the sheet. The printer cartridges may be aligned in an echelon, so as to cover a two inch wide area of the sheet. In this case the print heads 248 may each be associated with a two inch wide parallel area of the sheet. Inks and dyes of various types, visible or invisible, may be loaded into the print heads 248 depending on the type of media being marked. Alternatively or in addition solvents and/or solutions may be loaded into the print heads so that inks or coatings may be removed from the media, such as a card on a sheet, to reveal the substrate below. The print heads 248 and the print head controllers 244 may collectively be referred to as a printer or an imager, such as the VIDEO TECHNOLOGIES, INC. Model # SAR06130-VIDEO JET IMAGER.

The dryer 246, such as a FANNON PRODUCTS Model # FPW-480-9Z-16, may be an infra-red dryer, such as twenty seven infra-red tubes sixteen inches long, or any device capable of drying or curing the printed sheet. The stacker 247, such as a TEC LIGHTING, INC. # FED-002 Auto Pile Stacker, may stack, collate, or otherwise order the printed sheets as to prepare them for the next process.

The encoder 249, such as a BAUMER CH-8501, may be a device that mechanically tracks the speed of the vacuum conveyor 245 and converts this information to a digital signal. The encoder 249 may be in communication with the imaging application 234 and the print head controllers 244 and may communicate the speed of the vacuum conveyor 245 to these components. The print head controllers 244 may use the speed of the vacuum conveyor 245, along with the data from the photo eye 243 indicating when a sheet passes beneath the photo eye 243, to control the speed of the printing process, such as by controlling the speed of the print heads 248. For example, the print head controllers 244 may be programmed with the distance from the photo eye 243 to the print heads 248. If the print head controllers 244 know the distance a sheet may travel from the photo eye 243 to the print heads 248, the speed of the vacuum conveyor 245, and the time a sheet passes under the photo eye 243, then the print head controllers 244 may be able to identify when the sheet is passing beneath the print heads 248.

The imaging application 234 may report the speed of the vacuum conveyor 245, and the time when a sheet passes under the photo eye 243, to the user 110. Alternatively or in addition the imaging application 234 may process the data from the photo eye 243 and the encoder 249, and may communicate to the print head controllers 244, or the print heads 248, when the sheet has reached the print heads 248.

In operation, the user 110 may create layout data files, such as card data files and sheet layout data files, by using the interface 222 to interact with the sheet/card layout application 224. The layout data files may be stored in the data store 226. Once the user 110 has created each of the layout data files, the compiler 228 may compile each of the layout data files into machine data files. The machine data files may then be compiled into a master machine data file. The master machine data file may be communicated to the image control system 130, such as an input to the imaging application 234. The master machine data file may be loaded onto a removable storage medium and manually loaded on to the image control system 130, or the master machine data file may be communicated to the image control system 130 over a data connection, such as a network.

The imaging application 234 may communicate data, such as instructions, to the print head controllers 244 in the print system 140. The print head controllers 244 may communicate instructions to the print heads 248. The imaging application 234 may instruct the feeder 242 to present a sheet to the vacuum conveyor 245, or the feeder 242 may be manually started by the user 110. The vacuum conveyor 245 may move the sheet past the photo eye 243, to the print heads 248. When the leading edge of the sheet passes the photo eye 243, the photo eye 243 may act as a timing index and may send a signal to the imaging application 234, and/or the print head controllers 244, that the sheet is ready for printing.

The imaging application 234 may then activate the print head controllers 244 and print heads 248. Each of the print heads 248 may be assigned an area across the sheet and may print, or otherwise modify data, within the assigned area of the sheet. The encoder 249 may communicate with the print head controllers 244 to track the speed of the sheet so the print head controllers 244 can accurately instruct the print heads 248 to target specific areas on the sheet for imaging. In the case of a pre-printed sheet of cards, the sheet may be ten cards wide by ten cards long. The sheet may be presented to the print heads 248 so that the left edge of the cards passes under the print heads 248 first. Thus, in the case of four half-inch print cartridges, each print cartridge may cover a half-inch wide strip of a card, printing any data which may fall into that area.

After passing the print heads 248, the vacuum conveyor 245 may pass the sheets under the dryer 246 for curing or drying. The vacuum conveyor 245 may then move the sheets to the stacker 247 for stacking. Using twelve print heads 248, with four half-inch cartridges each, the process may be capable of handling forty inch by twenty-eight inch sheets or smaller, at rates approaching six thousand sheets per hour.

The user 110 may view or modify the imaging process on an interface 232, such as a display, in the image control system 130. Screens on the display may allow the user 110 to view the printing status of the master machine data file, the status of each of the components of the printing system 140, or may allow the user 110 to make adjustments to the imaging process.

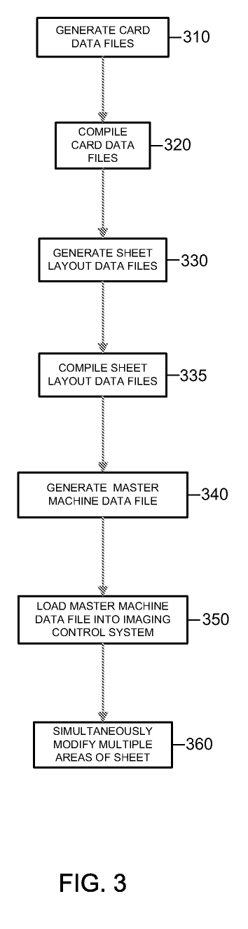

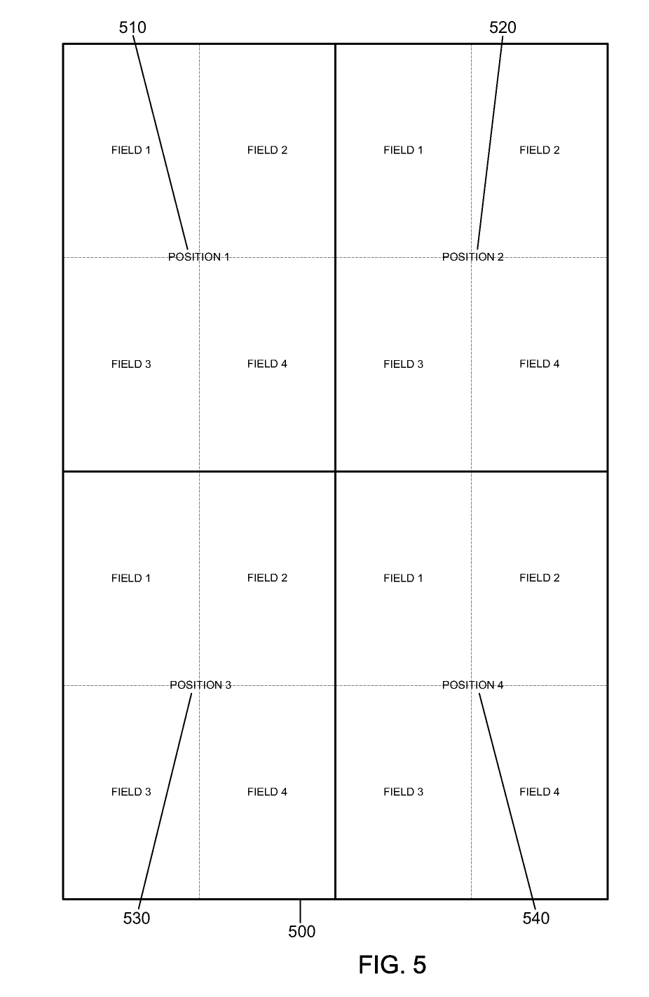

FIG. 3 is a flow chart illustrating operations of the systems of FIG. 1 and FIG. 2, or other systems for simultaneously modifying multiple areas of a sheet. At block 310 the user 110 may generate the card data files and card format files. The card data files may include information indicating the data to be applied to various areas of the card and the card format files may describe the number and size of fields on the card where data may be modified. The card data files may have one row of data for each sheet the card exists on. Each row of data may have one column for each area of the card data may be printed to. The column may indicate what data, if any, should be printed to the given area of the card. FIGS. 5-7 may provide more specific information regarding the card data files. At block 320 the compiler 228 may compile the card data files into a machine data file. The machine data files may contain all of the data from one card data file in a single cell separated by delimiters, such as commas.

At block 330 the user 110 may create one or more sheet layout data files. The sheet layout data files may contain the layout of the individual cards, relating to the individual card data files, on the sheet. The sheet layout file may be used to describe the structure of the sheet. For example, in the case of a one hundred card sheet, the sheet layout file may have a column of cells in which each cell may correspond to a card on the sheet. The first cell in the column may represent the first card on the sheet, the second cell may represent the second card on the sheet, all the way through to the last cell in the column which may represent the last card on the sheet. The data stored in these cells may be the name of the card data file corresponding to the particular card on the sheet. For example, if the third card on the sheet is a card called “Blazer” then the name of the file containing the card data file for “Blazer” may be stored in the third cell of the column in the sheet layout file.

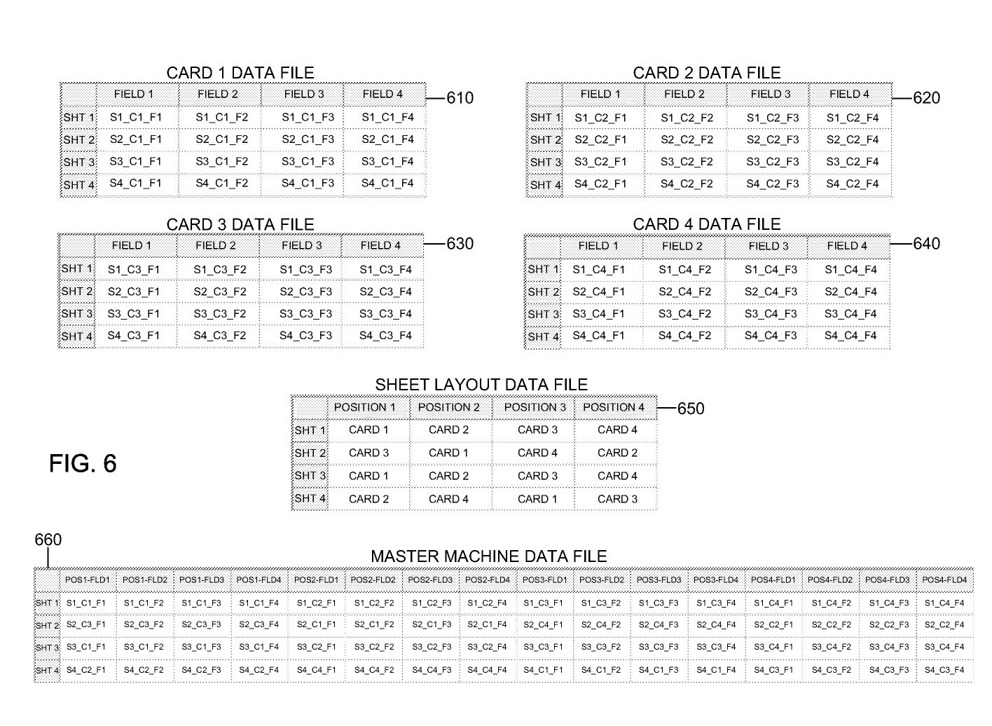

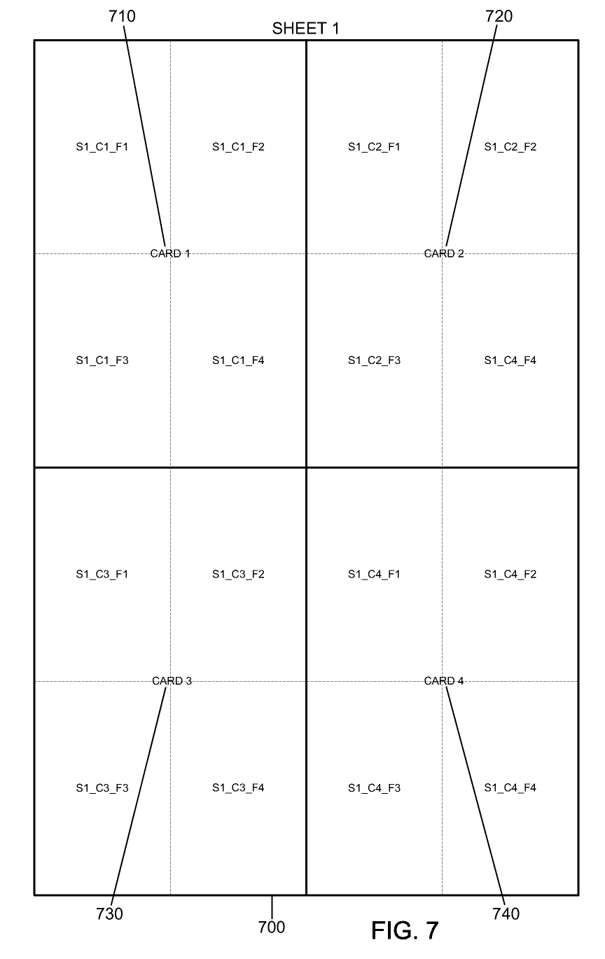

Alternatively or in addition if there is no data to be printed to a particular card, then a cell in an adjacent column may be provided as skip function for the card location. If the cell in the adjacent column is marked, such as with a checkmark, then the print head controller 244 may be issued an instruction to skip to the next card. FIGS. 6-7 may provide more specific information regarding the sheet layout data files.

At block 335 the compiler 228 may compile the sheet layout data files into machine data files. At block 340 the compiler 228 may compile the card machine data files and the sheet layout machine data files into a master machine data file. The master machine data file may include a row for each sheet being printed. Each row may contain the data to be applied to each area of each card, in the order indicated by the sheet layout data file. The master machine data file may contain the orientation and distribution of the data to be sent to the image control system 130, as well as the sequence and status of each sheet to be printed. FIGS. 6-7 may provide more specific information regarding the master machine data file.

At block 350 the master machine data file may be loaded into the image control system 130, such as loaded into the imaging application 234, and the card format files may be loaded onto the print head controllers 244, such as onto flash memory cards on the print head controllers 244. The master machine data file may be communicated from the design layout system 120 to the image control system 130 via a network or other data connection. Alternatively or in addition the master machine data file may be loaded onto a removable data storage medium and manually loaded into the image control system 130.

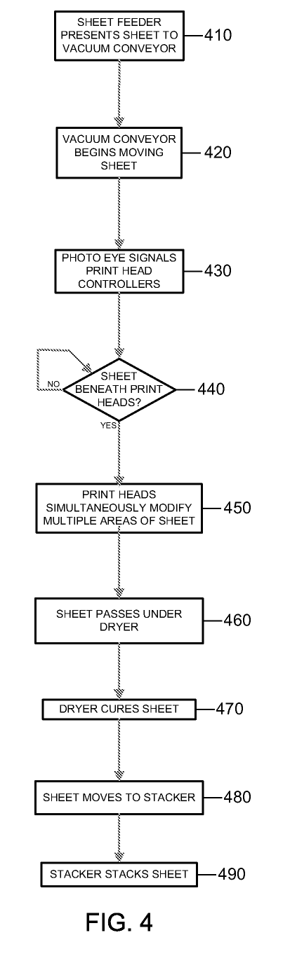

At block 360, the image control system 130 may use the data in the master machine data file to instruct the print system 140 to simultaneously modify multiple areas of the sheet. The image control system 130 may communicate instructions to the print head controllers 244. The print head controllers 244 may instruct the individual print heads 248 of the print system 140 to perform the modifications of the sheet. The operations of the print system 140 may be further explained in FIG. 4 below.

FIG. 4 is a flowchart illustrating steps that may be taken in the printing process in the systems of FIG. 1 and FIG. 2, or other systems for simultaneously modifying multiple areas of a sheet. In block 410 the sheet feeder 242 may feed a sheet to the vacuum conveyor 245. The sheet may be a printed sheet of collectible cards, a printed sheet of labels, a printed sheet of clothing tickets, an empty sheet, or generally any medium that may benefit from simultaneous modification of multiple areas. At block 420 the vacuum conveyor 245 may begin to move the sheet through the printing process. The vacuum conveyor 245 may continuously move the sheet through the components in the print process until the process is terminated at the stacker 247. At block 430, as the leading edge of the sheet passes under the photo eye 243, the photo eye 243 may send a signal to the print head controller 244, and/or the imaging application 234, indicating that a sheet is ready for printing. The encoder 249 may also send a signal to both components indicating the speed of the vacuum conveyor 245.

At block 440 the print head controllers 244 may use the data from the encoder 249 and the photo eye 243 to determine whether a sheet is beneath the print heads 248 and ready for modification. If a sheet has not passed beneath the print heads 248, the system 100 may return to block 435 and continue to wait until a sheet is ready for printing. If the print head controllers 244 determine that a sheet is passing beneath the print heads 248, the system 100 may move to block 450.

At block 450 the print heads 248 may receive instructions from the print head controllers 244 and may simultaneously modify multiple areas of the sheet. Each of the print heads 248 may be assigned an area of the sheet, such as a card or a specific section or field on a card, and may perform any modifications necessary within the assigned area. Each print head controller 244 may load a portion of the master data file relating to the current sheet and the cards each print head controller 244 may be responsible for.

For example, if each print head controller 244 controls two print heads 248 and each print head 248 contains four half-inch cartridges, each print head controller 244 may be responsible for a four inch wide area spanning the length of the sheet. If each card is two inches wide, then each print head controller 244 may be responsible for modifying data on two columns of cards. In this case, if the sheet has ten columns of cards, then the printing system 140 must include five print head controllers 244, each controlling two print heads 248, where each print head contains four half-inch cartridges.

At block 460 the vacuum conveyor 245 may move the modified sheet under the dryer 246. At block 470 the dryer 246 may cure the modified sheet by drying the sheet. At block 480 the vacuum conveyor 245 may move the cured sheet to the stacker 247. At block 490 the stacker 247 may stack the sheet, such as readying the sheet for any additional processing. Alternatively or in addition, the sheet may be further processed after being stacked, such as by being cut or collated. In the case of a sheet of cards, the sheet may be cut into individual cards by a cutting device, such as a HSM CM 3815 Guillotine.

FIG. 5 illustrates an exemplary sheet layout 500 in the systems of FIG. 1 and FIG. 2, or other systems for simultaneously modifying multiple areas of a sheet. The sheet layout may include a position 1 510, a position 2 520, a position 3 530 and a position 4 540. In the case of a sheet of cards, each of the positions 510-540 may indicate a card on the sheet. The sheet may have any number of positions and each position, may be described in the sheet layout data file. In the sheet layout 500 each of the positions 510-540 may comprise four fields: field 1, field 2, field 3, and field 4. Each field may represent an area within each position where the card may be modified by one of the print heads 248. The card data files may indicate what data may print in the field, if any.

FIG. 6 illustrates layout data files in systems of FIG. 1 and FIG. 2, or other systems for simultaneously modifying multiple areas of a sheet, such as the sheet depicted in FIG. 5. The layout data files may include the card 1 data file 610, card 2 data file 620, card 3 data file 630, card 4 data file 640, the sheet layout file 650 and the master machine data file 660. All of the depicted data files may be created in MICROSOFT EXCEL or any other program capable of storing delimited data.

The card data files 610-640 may include a row for every sheet the cards may be printed on. For example, the card represented by the card 1 data file 610 may be printed on four sheets, represented by the rows “SHT 1,” “SHT2,” “SHT3,” and “SHT4.” The card data files 610-640 may include a column for each modifiable area, or field, on the card. The number of fields on the card, and the boundaries of each field on the card may be described in a separate card format file found in the print head controllers 244. For example in the card data file 1 610, the row of “SHT 1” may indicate the values to be printed in the four fields on the card on “SHT 1.” Thus on sheet 1, the card represented by the card 1 data file 610 may have “S1_C1_F1” printed in field 1, “S1_C1_F2” printed in field 2, “S1_C1_F3” printed in field 3, and “S1_C1_F4” printed in field 4. The card layout data files 610-640 may demonstrate that different indicia can be printed on the card for each sheet the card is printed on.

The sheet layout data file 650 may indicate the layout, or orientation, of the cards represented by the card data files 610-640 on each of the sheets. For example, in the sheet layout data file 650, on sheet 1, card 1 may be printed in position 1, card 2 may be printed in position 2, card 3 may be printed in position 3, and card 4 may be printed in position 4. The locations of each of the positions may be described in the sheet layout data file. The sheet layout data file 650 may demonstrate that the cards may be laid out differently on each sheet.

The master machine data file 660 may describe the data to be printed to each field on each card on the sheet. Each row of the master machine data file 660 may represent a sheet of cards. Each column of the master machine data file 660 may represent the data to be printed to each card on the sheet. The data from the card data files 610-640 may be combined with the data in the sheet layout file 650 to generate the master machine data file 660. Thus in order to populate the row representing sheet 1 in the master machine data file 660, “SHT 1,” the system 100 may first retrieve the data from the sheet layout data file 650 indicating the orientation of the cards on the sheet. Once the orientation of the cards on the sheet is determined, the system 100 may retrieve the data from each of the individual card files 610-640 relating to the data to be printed to each field on the card.

For example, in the case of sheet 1, the system may retrieve the card in position 1 from the layout data file 650, card 1. The system may then retrieve the data to be printed on card 1 and sheet 1 from the card 1 data file 610. The system 100 may then populate the data in the master machine data file 660 for fields 1 through 4 on the card in position 1, card 1. The system 100 may repeat this process for each card on each sheet until the master machine data file 660 contains the data to be printed to each field on each card on each every sheet.

FIG. 7 illustrates an exemplary modified sheet 700 in the systems of FIG. 1 and FIG. 2, or other systems for simultaneously modifying multiple areas of a sheet. The modified sheet 700 may represent the data described in the layout data files depicted in FIG. 6 corresponding to “SHT 1.” Position 1 510 on the printed sheet 700 may contain card 1 610, position 2 520 may contain card 2 720, position 3 530 may contain card 3 730 and position 4 540 may contain card 4 740. Each of the cards 710-740 may have the data described in the card layout files 610-640 printed to the specified field on the cards 710-740.

For example, the data printed in field 1 of card 1 710 may be “S1_C1_F1,” as described by the first column, “POS1-FLD1,” of the “SHT 1” row in the master machine data file 660. The data printed in field 2 of card 4 740 may be “S1_C4_F2,” as described by the column “POS4-FLD2,” of the “SHT 1” row in the master machine data file 660. The printing heads 248 may have applied the data to each of the fields on each of the cards 710-740 simultaneously.

FIG. 8 illustrates a general computer system 800, which may represent a computer in the layout design system 120, the image control system 130, the print system 140, the print head controllers 244, or any of the other computing devices referenced herein. The computer system 800 may include a set of instructions 824 that may be executed to cause the computer system 800 to perform any one or more of the methods or computer based functions disclosed herein. The computer system 800 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 800 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 824 (sequential or otherwise) that specify actions to be taken by that machine. In a particular embodiment, the computer system 800 may be implemented using electronic devices that provide voice, video or data communication. Further, while a single computer system 800 may be illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, such as, a central processing unit (CPU), a graphics processing unit (GPU), or both. The processor 802 may be a component in a variety of systems. For example, the processor 802 may be part of a standard personal computer or a workstation. The processor 802 may be one or more general processors, digital signal processors, application specific integrated circuits, field programmable gate arrays, servers, networks, digital circuits, analog circuits, combinations thereof, or other now known or later developed devices for analyzing and processing data. The processor 802 may implement a software program, such as code generated manually (i.e., programmed).

The computer system 800 may include a memory 804 that can communicate via a bus 808. The memory 804 may be a main memory, a static memory, or a dynamic memory. The memory 804 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 804 may include a cache or random access memory for the processor 802. Alternatively or in addition, the memory 804 may be separate from the processor 802, such as a cache memory of a processor, the system memory, or other memory. The memory 804 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 804 may be operable to store instructions 824 executable by the processor 802. The functions, acts or tasks illustrated in the figures or described herein may be performed by the programmed processor 802 executing the instructions 824 stored in the memory 804. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 800 may further include a display 814, such as a liquid crystal display (LCD), an organic light emitting diode (OLED), a flat panel display, a solid state display, a cathode ray tube (CRT), a projector, a printer or other now known or later developed display device for outputting determined information. The display 814 may act as an interface for the user 110 to see the functioning of the processor 802, or specifically as an interface with the software stored in the memory 804 or in the drive unit 806.

Additionally, the computer system 800 may include an input device 812 configured to allow a user 110 to interact with any of the components of system 800. The input device 812 may be a number pad, a keyboard, or a cursor control device, such as a mouse, or a joystick, touch screen display, remote control or any other device operative to interact with the system 800.

The computer system 800 may also include a disk or optical drive unit 806. The disk drive unit 806 may include a computer-readable medium 822 in which one or more sets of instructions 824, e.g. software, can be embedded. Further, the instructions 824 may perform one or more of the methods or logic as described herein. The instructions 824 may reside completely, or at least partially, within the memory 804 and/or within the processor 802 during execution by the computer system 800. The memory 804 and the processor 802 also may include computer-readable media as discussed above.

The present disclosure contemplates a computer-readable medium 822 that includes instructions 824 or receives and executes instructions 824 responsive to a propagated signal; so that a device connected to a network 826 may communicate voice, video, audio, images or any other data over the network 826. Further, the instructions 824 may be transmitted or received over the network 826 via a communication interface 818. The communication interface 818 may be a part of the processor 802 or may be a separate component. The communication interface 818 may be created in software or may be a physical connection in hardware. The communication interface 818 may be configured to connect with a network 826, external media, the display 814, or any other components in system 800, or combinations thereof. The connection with the network 826 may be a physical connection, such as a wired Ethernet connection or may be established wirelessly as discussed below. Likewise, the additional connections with other components of the system 800 may be physical connections or may be established wirelessly.

The network 826 may include wired networks, wireless networks, or combinations thereof. The wireless network may be a cellular telephone network, an 802.11, 802.16, 802.20, or WiMax network. Further, the network 826 may be a public network, such as the Internet, a private network, such as an intranet, or combinations thereof, and may utilize a variety of networking protocols now available or later developed including, but not limited to TCP/IP based networking protocols.

The computer-readable medium 822 may be a single medium, or the computer-readable medium 822 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 822 may include a solid-state memory such as a memory card or other package that houses one or more non-volatile read-only memories. The computer-readable medium 822 also may be a random access memory or other volatile re-writable memory. Additionally, the computer-readable medium 822 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method for simultaneously modifying a plurality of areas on a sheet, comprising:
configuring a plurality of print heads so that each print head in the plurality of print heads is associated with an area in a plurality of areas on a sheet, wherein each print head is capable of modifying the area in the plurality of areas associated with the print head;
passing the sheet beneath the plurality of print heads on a conveyor; and
modifying the sheet with the plurality of print heads wherein each print head in the plurality of print heads simultaneously modifies the area in the plurality of areas associated with the print head.

2. The method of claim 1 further comprising configuring a photo eye wherein the photo eye is capable of identifying a location of the sheet on the conveyor.

3. The method of claim 2 further comprising configuring an encoder wherein the encoder is capable of identifying a speed of the sheet on the conveyor.

4. The method of claim 3 wherein the speed of the sheet and the location of the sheet are used to time the modification of the plurality of areas on the sheet.

5. The method of claim 1 wherein the sheet comprises a plurality of printed cards and each area in the plurality of areas comprises a boundary of at least one card in the plurality of cards.

6. The method of claim 5 wherein modifying the sheet comprises printing a unique indicia on each card in the plurality of cards.

7. The method of claim 1 wherein the print heads are controlled by at least one print head controller.

8. The method of claim 1 wherein the areas in the plurality of areas are parallel to one another.

9. A card product containing a printed unique identifier, the unique identifier printed by a process comprising the steps of:
(a) configuring a plurality of print heads so that each print head in the plurality of print heads is associated with a card in a plurality of cards on a sheet, wherein each print head is capable of printing a unique indicia on the card in the plurality of cards associated with the print head;
(b) passing the sheet beneath the plurality of print heads;
(c) printing the unique indicia on each card in the plurality of cards wherein each print head in the plurality of print heads simultaneously prints the unique indicia on the card in the plurality of cards associated with the print head; and
(d) cutting the sheet into the plurality of individual cards.

10. The card containing the printed unique identifier by process according to claim 9 wherein at least one print head controller controls the plurality of print heads.

11. The card containing the printed unique identifier by process according to claim 9 further comprising configuring a photo eye wherein the photo eye is capable of identifying a location of the sheet on the conveyor.

12. The card containing the printed unique identifier by process according to claim 9 further comprising configuring an encoder wherein the encoder is capable of identifying a speed of the sheet on the conveyor.

13. The card containing the printed unique identifier by process according to claim 9 wherein the unique identifier on each card in the plurality of cards may be used to identify the other cards in the plurality of cards on the sheet.

14. A system for simultaneously modifying a plurality of areas on a sheet, comprising:
a plurality of print heads configured to modify a plurality of areas on a sheet;
a sheet comprising a plurality of areas;
a conveyor to pass the sheet beneath the plurality of print heads;
a memory to store a set of data comprising a plurality of modifications to the plurality of areas on the sheet;
an interface operatively connected to the memory, the interface to receive the set of data;
a processor operatively connected to the conveyor, the memory, the interface, and the plurality of print heads, the processor for running instructions, wherein the processor receives the set of data via the interface, associates each print head in the plurality of print heads to each area in the plurality of areas and to each modification in the plurality of modifications, instructs the conveyor to pass a sheet beneath the plurality of print heads, and instructs the plurality of print heads to simultaneously modify the plurality of areas on the sheet based on the plurality of modifications, wherein each print head in the plurality of print heads simultaneously performs the modification in the plurality of modifications associated with each print head on the area in the plurality of areas associated with each print head.

15. The system of claim 14 wherein at least one modification in the plurality of modifications comprises printing a unique indicia on at least one area in the plurality of areas.

16. The system of claim 14 wherein at least one modification in the plurality of modifications comprises applying a solvent to at least one area in the plurality of areas, wherein the solvent is capable of removing an ink or coating from the at least one area in the plurality of areas,

17. The system of claim 14 wherein the sheet comprises a plurality of printed cards further wherein each area in the plurality of areas forms a boundary around each printed card in the plurality of printed cards.

18. The system of claim 14 further comprising an encoder, wherein the encoder is operatively connected to the processor and communicates a speed of the conveyor to the processor.

19. The system of claim 14 further comprising a photo eye wherein the photo eye is operatively connected to the processor and is capable of communicates a location of the sheet on the conveyor to the processor.

20. The system of claim 14 further comprising a display, wherein the display is operatively connected to the processor and displays an information relating to the system to a user.
